(19) United States
(12) Patent Application Publication
(10) Pub. No.: US 2003/0061429 A1
(43) Pub. Date: Mar. 27, 2003

(54) Synchronizer for processor facility and PCMCIA card

(76) Inventor: Ming Hsiu Wu, Chong Ho City (TW)

Correspondence Address: Ming Hsiu Wu, Chong Ho, P.O. Box 10-69, Taipei, 235, TW

(21) Appl. No.: 09/965,271

(22) Filed: Sep. 24, 2001

(51) Int. Cl. G06F 13/00

(52) U.S. Cl. 710/300

(57) ABSTRACT

A processor facility includes a CPU and a PCMCIA card coupled with each other with a data or address or control bus. The PCMCIA card is coupled to the peripheral facilities. A device is used for postponing the CPU to take information from the PCMCIA card, and includes a comparator member coupled between the CPU and the PCMCIA card, and a comparator device coupled between the comparator member and the PCMCIA card. The postponing device may postpone the CPU to take information from the PCMCIA card when the PCMCIA card has a processing speed less than that of the CPU.

### BACKGROUND OF THE INVENTION

1. Field of the Invention

The present invention relates to a synchronizer or a synchronizing device, and more particularly to a synchronizing device for synchronizing or for communicating between a central processing unit (abbreviated as CPU hereinafter) and a personal computer memory card international association card (abbreviated as PCMCIA card hereinafter) of a processor facility or the like.

2. Description of the Prior Art

Typical processor facilities, such as the computers, programmable machines, or the like, as shown in FIG. 1, comprise a central processing unit (CPU) 1 and a PCMCIA card 2 communicated with each other with a data bus and/or an address bus, and a control bus. The PCMCIA card 2 is provided for coupling to or for being disposed in either or all of the peripheral facilities of the computers, programmable machines, or the like, such as the printers, the numerical control machines, plotters, etc. The control bus may include such as a chip select cable, a read/write cable, and a wait cable communicated or coupled between the CPU 1 and the PCMCIA card 2 for transferring the information between the CPU 1 and the PCMCIA card 2, and for controlling between the CPU 1 and the PCMCIA card 2. When the peripheral facilities may not be ready or may not be used yet the PCMCIA card 2 may send out a “wait” signal to the CPU 1 with the wait cable, for postponing the communication between the CPU 1 and the peripheral facilities, and for allowing the CPU 1 to take the data or the information from the peripheral facilities later or while the peripheral facilities are ready.

However, the processing speed for the PCMCIA card 2 is less than that of the CPU 1. Heretofore, the processing speed of the CPU 1 has been increased from 4 MHz to 8 MHz, for example. But, recently, the processing speed of the CPU 1 has been greatly and quickly increased from 8 MHz to hundreds of MHz, and has even been greatly and quickly increased to giga Hz, such that the difference between the processing speeds of the CPU 1 and the PCMCIA card 2 has become more and more large. As shown in FIGS. 2 and 3, when the difference between the processing speeds of the CPU 1 and the PCMCIA card 2 has become greater and greater, the data or the information from the peripheral facilities may not be completely taken by the CPU 1 between the time interval T0 and T1, and may not be suitably taken by the CPU 1 at the instant or the moment A. The synchronizing or the communicating between the CPU and the PCMCIA card of the processor facilities are required to be suitably improved.

The present invention has arisen to mitigate and/or obviate the afore-described disadvantages of the conventional processor facilities.

### SUMMARY OF THE INVENTION

The primary objective of the present invention is to provide a synchronizing device for synchronizing a central processing unit and a PCMCIA card of a processor facility and for allowing the information or signals to be appropriately communicated or transferred between the central processing unit and the PCMCIA card of the processor facility.

In accordance with one aspect of the invention, there is provided a processor facility comprising a CPU, a PCMCIA card, and means for connecting the CPU and the PCMCIA card together, and means for postponing the CPU to take information from the PCMCIA card.

The postponing means includes a comparator member coupled between the CPU and the PCMCIA card, and includes a comparator device coupled between the comparator member and the PCMCIA card, the comparator member includes a first inlet coupled to the PCMCIA card and a second inlet coupled to the comparator device, the comparator device includes a first inlet coupled to the PCMCIA card.

The connecting means includes a control bus having a chip select cable coupled between the CPU and the PCMCIA card, the comparator device includes a second inlet coupled to the chip select cable.

The postponing means includes a flip-flop having an outlet coupled to the comparator device, the flip-flop includes a first inlet coupled to the CPU for receiving signals from the CPU.

The postponing means includes a signal intake device, the flip-flop includes a second inlet coupled to the signal intake device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram illustrating one the typical processor facilities having a central processing unit and a PCMCIA card;

FIGS. 2 and 3 are schematic views illustrating the communication or the transferring between the central processing unit and the PCMCIA card of the typical processor facilities;

FIGS. 4 and 5 are block diagrams illustrating a processor facility in accordance with the present invention;

FIG. 6 is an electric circuit of the processor facility in accordance with the present invention; and

FIGS. 7 and 8 are schematic views illustrating the communication or the transferring between the central processing unit and the PCMCIA card of the processor facility via a synchronizing device.

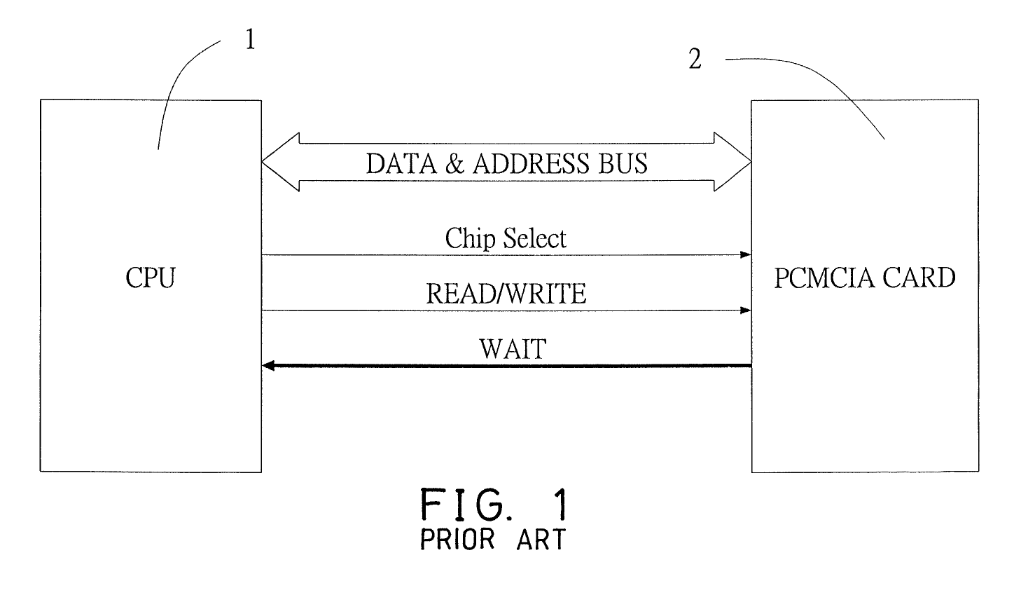

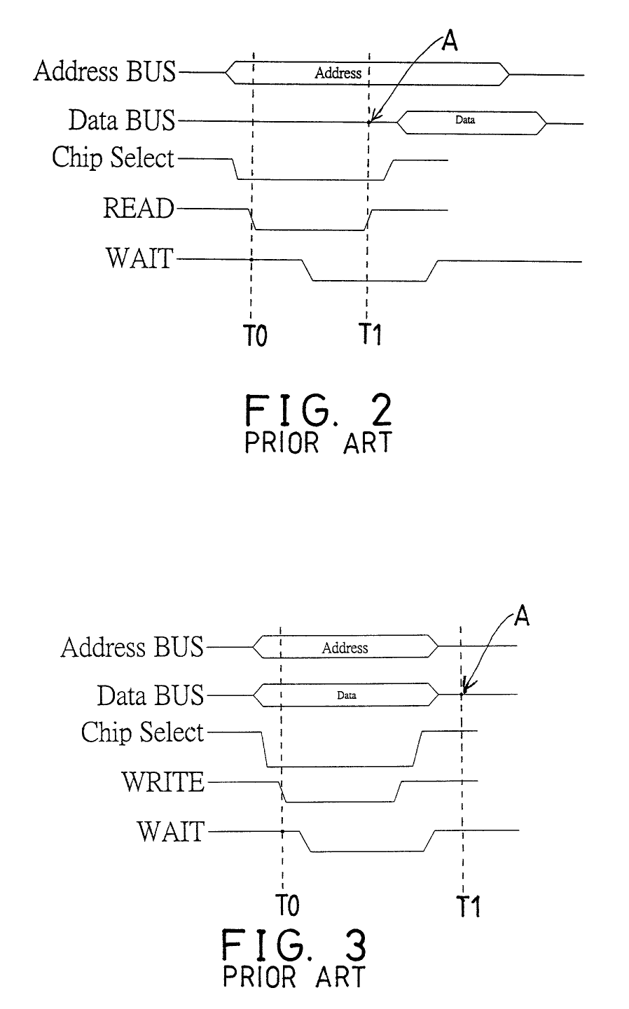

### DETAILED DESCRIPTION OF THE PREFERRED EMBODIMENT

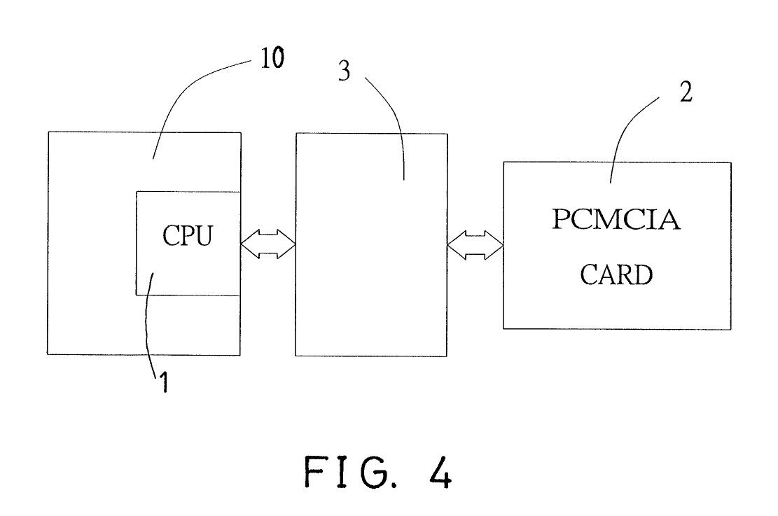

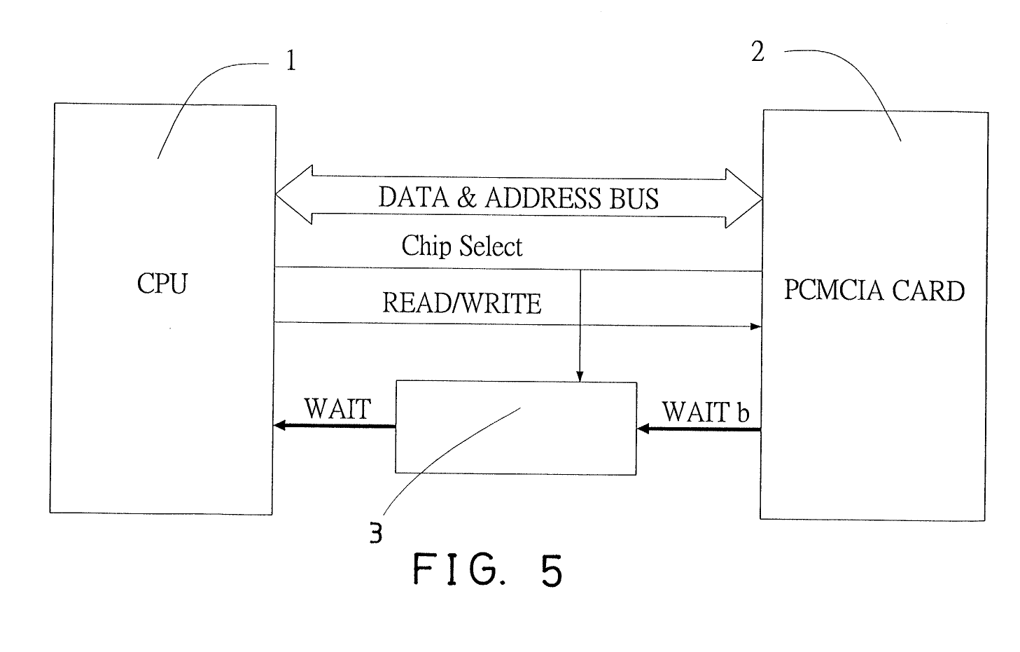

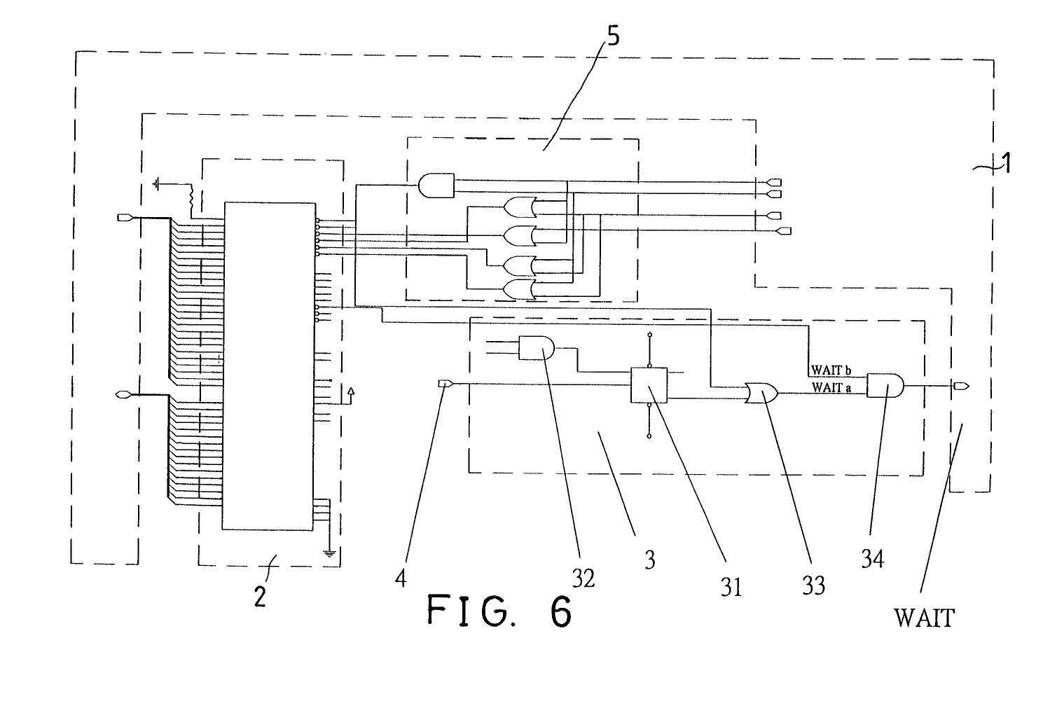

Referring to the drawings, and initially to FIG. 4, a synchronizing device 3 in accordance with the present invention is provided for being coupled between a CPU 1 and a PCMCIA card 2 of a processor facility, such as the computers 10, programmable machines, or the like. The CPU 1 may be disposed or built in the computers 10 or the like. Referring next to FIGS. 5 and 6, the CPU 1 and the PCMCIA card 2 may also be communicated with each other with a data bus and/or an address bus and/or a control bus. The PCMCIA card 2 may also be provided for coupling to or for being disposed in either or all of the peripheral facilities 5 (FIG. 6), such as the printers, the numerical control machines, plotters, etc. The control bus may include such as a chip select cable, a read/write cable, and a wait cable similar to the prior arts. The synchronizing device 3 may be coupled between the CPU 1 and the PCMCIA card 2 with the wait cable or the like, for facilitating the transferring or the communication between the CPU 1 and the peripheral facilities, and for allowing the CPU 1 to appropriately take the data or the information from the peripheral facilities.

As shown in FIG. 6, the synchronizing device 3 includes a gate, such as an AND gate, or a signal intake device 32 coupled to the other facilities with a read cable and a write cable, for example, for receiving or for transferring the signals from or to the other facilities. The signal intake device 32 includes an outlet coupled to a flip-flop 31 which is also coupled to the CPU 1 for receiving the pulse or the clock or the signals from the CPU 1. For example, when the other facilities have not sent any signal to the signal intake device 32 via the read cable or the write cable or when the other facilities have not been ready to be used yet, the signals from the read cable and/or the write cable may be determined as “low”, and the outlet of the signal intake device 32 may also send out a “low” signal to the flip-flop 31.

The flip-flop 31 has an outlet coupled to an inlet of another gate, such as an OR gate, or a comparator device 33. The comparator device 33 has another inlet coupled to such as the chip select cable for determining or judging whether the information has been transferred between the CPU 1 and the PCMCIA card 2 or not. For example, when the other facilities have not been ready to be used yet and have sent the “low”signal to the signal intake device 32, the flip-flop 31 will also receive the “low” signal to the comparator device 33. Another “low” signal will also be sent to the comparator device 33 when no data or information has been transferred between the CPU 1 and the PCMCIA card 2 via the chip select cable, for example. When either the chip select cable or the signal intake device 32 has sent out the “low” signal to the comparator device 33, the comparator device 33 will send out the “low” signal to the other facilities. Otherwise, the comparator device 33 will send out the “high” signal to the other facilities.

The comparator device 33 has an outlet coupled to an inlet of another gate, such as an OR gate, or another comparator member 34, with such as a WAITa cable. The comparator member 34 has another inlet coupled to the PCMCIA card 2 with a WAITb cable for receiving the signals from the PCMCIA card 2 and from the comparator device 33. The comparator member 34 has an outlet coupled to the CPU 1 with a WAIT cable for sending the signals to the CPU 1. When either the WAITa or the WAITb cable has sent out the “low” signal to the comparator member 34, the comparator member 34 will send out the “low” signal to the CPU 1, for postponing or delaying the CPU 1 to receive the signals from the PCMCIA card 2 or from the peripheral facilities that have not been ready for use yet.

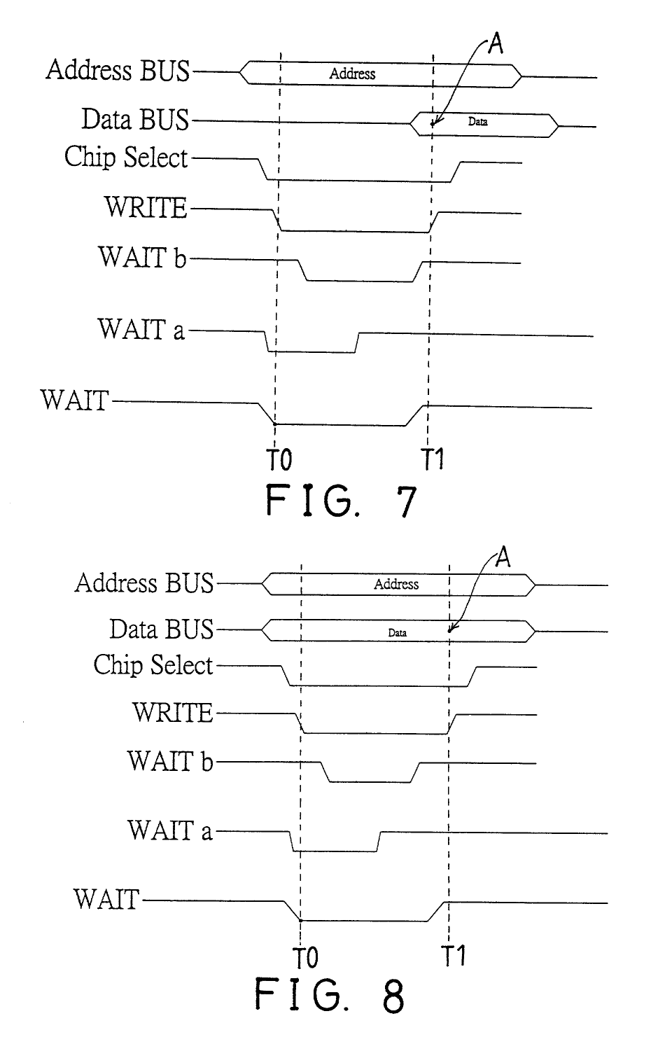

In operation, as shown in FIGS. 5-8, when the peripheral facilities have not been ready for use yet, a “low” signal will be sent out to the comparator member 34 via the WAITb cable, and the comparator member 34 will send out the “low” signal to the CPU 1, for postponing or delaying the CPU 1 to receive the signals from the PCMCIA card 2 and for allowing the CPU 1 to appropriately take the data or the information between the time intervals T0 and T1 and/or at the instant or the moment A (FIGS. 7 and 8), and thus for allowing the CPU 1 to take the data or the information from the peripheral facilities when the processing speeds of the CPU 1 and the PCMCIA card 2 have a great difference therebetween.

The elements of the synchronizing device may be the transistor members, the programmable devices, the gating circuits or the like.

Accordingly, the synchronizing device in accordance with the present invention may be used for synchronizing a central processing unit and a PCMCIA card of a processor facility and for allowing the information or signals to be appropriately communicated or transferred between the central processing unit and the PCMCIA card of the processor facility.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A processor facility comprising:
a CPU,
a PCMCIA card, and
means for connecting said CPU and said PCMCIA card together, and
means for postponing said CPU to take information from said PCMCIA card.

2. The processor facility according to claim 1, wherein said postponing means includes a comparator member coupled between said CPU and said PCMCIA card.

3. The processor facility according to claim 2, wherein said postponing means includes a comparator device coupled between said comparator member and said PCMCIA card, said comparator member includes a first inlet coupled to said PCMCIA card and a second inlet coupled to said comparator device, said comparator device includes a first inlet coupled to said PCMCIA card.

4. The processor facility according to claim 3, wherein said connecting means includes a control bus having a chip select cable coupled between said CPU and said PCMCIA card, said comparator device includes a second inlet coupled to said chip select cable.

5. The processor facility according to claim 3, wherein said postponing means includes a flip-flop having an outlet coupled to said comparator device, said flip-flop includes a first inlet coupled to said CPU for receiving signals from said CPU.

6. The processor facility according to claim 5, wherein said postponing means includes a signal intake device, said flip-flop includes a second inlet coupled to said signal intake device.
